(19) United States
(12) Patent Application Publication
(10) Pub. No.: US 2008/0075886 A1
(43) Pub. Date: Mar. 27, 2008

(54) METHOD OF SUPPRESSING ELUTION OF NICKEL AND COBALT FROM STRUCTURAL MATERIAL

(76) Inventors: Makoto NAGASE, Mito (JP); Hideyuki Hosokawa, Hitachinaka (JP); Kazushige Ishida, Hitachi (JP); Satoshi Morisawa, Hitachi (JP); Motoaki Sakashita, Hitachi (JP); Motohiro Aizawa, Hitachi (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/839,939

(22) Filed: Aug. 16, 2007

(30) Foreign Application Priority Data
Aug. 22, 2006 (JP) 2006-225331

(51) Int. Cl. B01J 19/10

(52) U.S. Cl. 427/560; 118/56; 427/331

(57) ABSTRACT

A nuclear reactor structural material (for example, a spacer spring) is immersed in purified water in a treatment bath. The temperature of the purified water increased to 90° C. by a heater. Iron formate (a solution containing iron (II) ions) in an iron formate tank, hydrogen peroxide in a hydrogen peroxide tank, and hydrazine in a hydrazine tank are injected into a pipe and are guided into the treatment bath. The injection of iron formate is performed until the concentration of iron (II) ions in the purified water becomes 200 ppm or more. By injecting hydrazine, pH is adjusted in a range of from 5.5 to 9.0. A portion of a magnetite film thus formed on the structural material is then removed, e.g., by applying ultrasonic waves. With this process, a fine strong magnetite film for suppressing the elution of cobalt from the nuclear reactor structural material is formed on the surface of the nuclear reactor structural material.

### BACKGROUND OF THE INVENTION

The present invention relates to a method of suppressing the elution of nickel and cobalt from a structural material. More particularly, the invention relates to a method of suppressing the elution of nickel and cobalt from a structural material, which is suitable for suppressing the elution of nickel and cobalt from a nickel-based alloy or a cobalt-based alloy which is a structural material for constructing a nuclear power plant.

In a boiling water reactor nuclear power plant (hereinafter, referred to as a BWR plant), since a corrosion product is generated from a structural material which contacts primary cooling water of a recirculation system of a nuclear reactor, stainless steel having a high resistance to corrosion, or stainless steel such as a nickel-based alloy, is used as a main primary system structural material. A low-alloy steel reactor pressure vessel, which is a main device of a nuclear reactor of the BWR plant, is subjected to inner surface welding of stainless steel such that the low-alloy steel is prevented from directly contacting cooling water (reactor water) in the nuclear reactor. In addition to such consideration to the structural material, the reactor water is purified using a reactor water purifying device of a reactor purifying system connected to the nuclear reactor. Metal impurities which are slightly generated in the reactor water are actively eliminated by the purification of the reactor water.

However, even in a case of considering a corrosion countermeasure, a slight amount of the metal impurities cannot be prevented from being contained in the reactor water. Accordingly, some of the metal impurities deposit as metal oxide on the surface of a fuel rod included in a fuel assembly loaded in a core of the nuclear reactor. The metal element deposited to the surface of the fuel rod causes a nuclear reaction with neutrons generated by fission of nuclear fuel, thereby generating radioactive nuclides such as cobalt 60, cobalt 58, chrome 51 and manganese 54. These radioactive nuclides are mostly attached to the surface of the fuel rod in the form of oxide. However, some of the radioactive nuclides are eluted to the cooling water according to the solubility of the contained oxide or released to the reactor water as an insoluble solid called a crud.

In addition, the structural materials of the core and an internal furnace device located in the vicinity thereof (for example, a fuel spacer, a shroud, a jet pump, an upper grid plate, a lower grid plate, a steam separator, and a neutron instrumentation guide tube) are irradiated by neutrons. Accordingly, a corrosion product exposed to cooling water due to the corrosion of the structural materials of those devices contains the radioactive nuclides.

A radioactive material contained in the reactor water is accumulated on the surface of a structural material of stainless steel and inconel and the surface of a structural material of carbon steel used in a pipe of a reactor purifying system, each of which contact the reactor water. As a result, radiation rays from the surface of the structural material cause radiation exposure of a worker during periodic inspection. In particular, since an advanced type BWR (ABWR) does not have a recirculation pipe, a carbon steel pipe such as a reactor water purifying system and a residual heat removal system have a large influence on the atmospheric dose inside a reactor containment vessel. The radiation exposure while working is managed not to exceed an allowable dose with respect to every worker. In recent years, the allowable dose has been reduced.

Suppressing the elution of cobalt from the irradiated structural material efficiently reduces the concentration of the radioactive nuclides contained in the reactor water, and more particularly, radioactive cobalt. Accordingly, a spring made of inconel and used in the fuel spacer of a fuel assembly loaded in the core uses a low cobalt content material, and an oxide film is previously formed at a high temperature in the atmosphere because a corrosion rate is reduced (JP-A-63-21590).

A method of forming a ferrite film on the surface of a structural material which contacts reactor water in a BWR plant is disclosed in JP-A-2006-38483. The ferrite film is formed using an oxidizing agent and a pH adjuster, namely an agent containing iron (II) ions adjusted by dissolving iron with formic acid.

A method of forming a ferrite film on the surface of a stainless substrate in a magnetic recording medium is disclosed in JP-A-63-15990.

However, as disclosed in JP-A-63-21590, since inconel is corroded by the elution even when the oxide film is previously formed on the surface of the structural material, the stability of the oxide film formed from a base material is not necessarily high. Accordingly, the whole inconel of the fuel spacer (that is, the dramatic increase of area-in-water), which is being studied for the increase of the high burnup (that is, long-period use) of the fuel assembly and the improvement of the output of the nuclear reactor, may not achieve a sufficient effect in view of the suppression of the elution of nickel and cobalt.

In the method disclosed in JP-A-2006-38483, the present inventors found that nickel and cobalt, which are parent nuclides of radioactive cobalt, are eluted from the surface of the structural material which contacts the reactor water even when the ferrite film (for example, a magnetite film) is formed on the surface of the nuclear reactor structural material.

### SUMMARY OF THE INVENTION

An object of the invention is to provide a method of suppressing the elution of nickel and cobalt from a structural material, which is capable of further reducing the elution of nickel and cobalt which are parent nuclides of a radioactive nuclide.

The present invention is characterized in that an iron oxide film is formed on the surface of the structural material used in a nuclear power plant, which is any one of a nickel-based alloy and a cobalt-based alloy which contacts a primary coolant of a nuclear reactor; and ultrasonic waves are applied to the structural material having the iron oxide film formed thereon.

By the ultrasonic waves applied to the structural material having the iron oxide film formed thereon, the iron oxide film having a weak bonding force among the iron oxide films formed on the surface of the structural material is removed. A fine iron oxide film is left on the surface of the structural material. It is possible to reduce the elution of nickel and cobalt, which are the parent nuclides of radioactive nuclides and contained in the structural material, by the fine iron oxide film. Since the iron oxide film having the weak bonding force is removed, it is possible to suppress the elution of nickel and cobalt from the iron oxide film having the weak bonding force on the surface of the structural material into the primary coolant while driving the nuclear reactor. Accordingly, it is possible to further reduce the elution of nickel and cobalt from the structural material to the primary coolant.

The present inventors examined a variety of methods in order to solve the above-described problems. As a result, it was confirmed that it is possible to suppress the elution of nickel and cobalt (parent nuclides of cobalt 58 and cobalt 60 which are the radioactive nuclides) from the base metal by forming the fine film of magnetite in a temperature condition (e.g., 100° C. or less) that causes the diffusion rate of dissolved oxygen into the parent metal to be low.

It is difficult to measure the elution rate of nickel and cobalt from a metal such as stellite (which is a cobalt-based alloy mainly containing cobalt) or inconel (which is a nickel-based alloy mainly containing nickel) with high precision. The nickel-based alloy contains cobalt as impurities and the cobalt-based alloy contains nickel as impurities. Since the high-precision measurement of the elution rate of nickel and cobalt is difficult, the inventors evaluated the deposition amount of radioactive cobalt to a test piece having the fine magnetite film. That is, when a test piece in which the fine magnetite film is formed on the surface of stainless steel and a test piece in which the magnetite film is not formed on the surface of stainless steel are immersed in high-temperature water under the common driving condition of a BWR, the deposition amounts of cobalt 60 in the test pieces were measured. The measured results are shown in FIG. 6. The magnetite film is not formed in test piece A, whereas the fine film is formed in test piece B. The deposition amount of cobalt 60 in test piece B is suppressed to about ⅕ of that in test piece A. Since the corrosion rate of the base metal of the structural material and the attachment rate of the radioactive nuclides are proportional to each other, the corrosion of the parent material in test piece B is suppressed to about ⅕ of that in test piece A.

Even using a technique described in JP-A-2006-38483, the fine magnetite film can be formed on the surface of the base metal used as the structural material. The magnetite film is formed on the surface of stainless steel used as a base metal, using an agent containing iron (II) ions produced by dissolving iron with formic acid, oxygen (oxidant), and hydrazine (pH adjuster). The present inventors newly found that, although the magnetite film is formed on the surface of the stainless steel by the method disclosed in JP-A-2006-38483, the magnetite film containing nickel and cobalt, which are the parent nuclides of radioactive cobalt, is stripped and becomes a transition medium of radioactive cobalt. The present inventors found further that the magnetite film formed by the method of JP-A-2006-38483 includes a fine strong magnetite film (hereinafter, referred to as a first magnetite film) formed on the surface of the base metal (structural material) and a coarse magnetite film (hereinafter, referred to as a second magnetite film) having a weak bonding force and formed on the surface of the fine magnetite film, by examining the strip behavior of the magnetite containing the parent nuclides. Since the second magnetite film has the weak bonding force, it can be seen that nickel and cobalt contained in the film is apt to be stripped from the film.

When the first magnetite film is prompted to be formed on the surface of stainless steel and the second magnetite film is prevented from being formed, it is possible to suppress the transition of nickel and cobalt which are the parent nuclides. However, it is difficult to form the second magnetite film. Accordingly, the present inventors removed the formed second magnetite film by changing the concept. The present inventors newly found that ultrasonic waves are applied to stainless steel (base metal) having the first and second magnetite films formed thereon to remove the second magnetite film, by examining a variety of methods for removing the second magnetite film. This is realized because the bonding force of the second magnetite film is lower than that of the first magnetite film and the first magnetite film was not removed from the stainless steel as the base metal. The test piece B is prepared by the new method found by the present inventors, for example, the use of an agent containing iron (II) ions produced by dissolving iron with formic acid, oxygen, and hydrazine, and the use of the ultrasonic waves. The second magnetite film may be removed using a brush, instead of the application of the ultrasonic waves.

The suppression effect of the elution of cobalt disclosed in JP-A-63-21590 is ⅓ to ¼. When the magnetite film is formed on the base metal (structural material) by applying the ultrasonic waves, the suppression effect of the elution of nickel and cobalt which are the parent nuclides is about ⅕, which represents a remarkable increases.

The corrosion rate of an inconel material (a nickel-based alloy material) is about 7 times that of stainless steel, and the corrosion rate of a stellite (a cobalt-based alloy material) is about 10 times that of stainless steel. Accordingly, when a fine magnetite film is formed on the surfaces of the inconel material and the stellite material, the corrosion rate of the former material is reduced to about 1/35 compared with the inconel material in which the film is not formed, and the corrosion rate of the latter material is reduced to about 1/50 compared with the stellite material in which the film is not formed. That is, the amount of nickel and cobalt, which are the parent nuclides, eluted by the corrosion can be reduced proportional to the corrosion rate. The formation of the first magnetite on the surfaces of the inconel material and the stellite surface is performed by forming the first and second magnetite films by the method disclosed in JP-A-2006-38483 and applying the ultrasonic waves to remove the second magnetite film.

Since the used agent (agent containing iron (II) ions) becomes radioactive waste in a nuclear power plant such as a BWR plant, an organic acid which can be decomposed into carbon dioxide and water is preferably used as the agent. As the decomposable organic acid which dissolves divalent iron ions, there are formic acid, malonic acid, diglycol acid, and oxalic acid. In experiments, a fine magnetite film was formed by any one of the above-described organic acids. However, formic acid is most preferable in view of the uniformity and the generation rate of the magnetite film.

Although a treated material does not exist immediately after the treatment liquid is mixed, minute particles of the magnetite begin to be generated in the liquid. An oxidant and a pH adjuster need to be added to the liquid containing divalent iron ions immediately before the magnetite film begins to be formed on the structural material.

The structural material which is used in the nuclear power plant and on which the first magnetite film is formed may be a spring of a fuel spacer or a pin and roller of a control rod used in a core of a nuclear reactor, a jet pump provided in the nuclear reactor, or a valve provided in a pipe of a primary cooling system of the nuclear reactor. The magnetite film is not limited to the above-described members, and may be formed on the surface of the structural material (for example, a heat transfer tube provided in a heat exchanger of a nuclear reactor purifying system) which contacts a coolant (for example, reactor water) of the primary cooling system of the nuclear reactor. The magnetite film may be formed on the surface of the heat transfer tube of a steam generator of a PWR plant. Accordingly, it is possible to suppress the elution of the parent nuclides (e.g., nickel and cobalt, which are the radioactive nuclides) from the surface of the heat transfer tube.

A hematite film may be formed on the surface of the nuclear reactor structural material, instead of the first magnetite film.

According to the present invention, it is possible to further suppress the elution of nickel and cobalt from a structural material, which is any one of a nickel-based alloy and a cobalt-based alloy, into a primary coolant of a nuclear reactor.

### BRIEF DESCRIPTION OF THE DRAWINGS

Other objects and advantages of the invention will become apparent from the following description of embodiments with reference to the accompanying drawings in which:

FIG. 1 is a systematic diagram of a film forming device applied to a method of suppressing the elution of nickel and cobalt from a structural material of a nuclear reactor according to a first preferred embodiment of the present invention.

FIG. 2 is a flowchart showing a method of forming a magnetite film on a spacer spring to manufacture a fuel spacer.

FIG. 3 is a vertical cross-sectional view of the surface of a nuclear reactor configuration member applied with a method of suppressing the elution of nickel and cobalt from a nuclear reactor structural material according to the first embodiment.

FIG. 4 is a vertical cross-sectional view of the surface of the nuclear reactor configuration member in a state that the method of suppressing the elution of nickel and cobalt according to the first embodiment is not applied.

FIG. 5 is a view showing a variation in concentration of cobalt 58 contained in reactor water depending on nuclear reactor operation hours, when a fuel assembly having a fuel spacer containing a spacer spring applied with the method of suppressing the elution of nickel and cobalt according to the first embodiment is loaded in a core.

FIG. 6 is a view showing an experimental result of the amount of cobalt 60 deposited on a test piece in which a first magnetite film is formed on the surface of a stainless steel material.

FIG. 7 is a flowchart showing a method of manufacturing a fuel spacer applied with a method of suppressing the elution of nickel and cobalt from a nuclear reactor structural material according to a second preferred embodiment of the present invention.

FIG. 8 is a vertical cross-sectional view of the surface of a pin (or a roller) applied with a method of suppressing the elution of nickel and cobalt from a nuclear reactor structural material according to a third preferred embodiment of the present invention.

### DETAILED DESCRIPTION OF THE PREFERRED EMBODIMENTS

Hereinafter, embodiments of the present invention will be described.

### First Embodiment

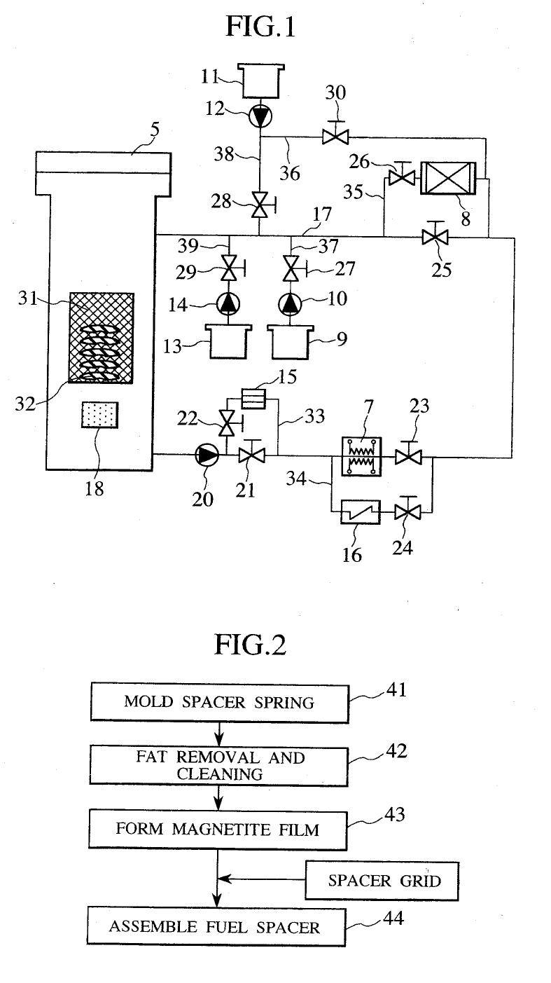

A method of suppressing the elution of nickel and cobalt from a structural material according to a first preferred embodiment of the present invention will be described with reference to FIGS. 1 to 3.

First, the outline of a BWR plant will be described, in which a structural material having a first magnetite film formed thereon is used according to the method of suppressing the elution of nickel and cobalt from the structural material. The BWR plant has a nuclear reactor having a core in which a plurality of fuel assemblies are loaded and cooling water is fed to the core by a recirculation pump (or an internal pump). The cooling water is heated by heat generated by fission of nuclear fuel in a fuel rod included in each fuel assembly, thereby generating steam. Most of the generated steam is guided from the nuclear reactor to a turbine to drive the turbine. A generator connected to the turbine rotates to generate electricity. The steam discharged from the turbine is condensed in a condenser. Water generated by condensing steam is fed to the nuclear reactor through a feeding pipe as cooling water. Oxygen and hydrogen generated by radiolysis of the cooling water in the core are substantially completely removed in the condenser. In order to suppress the generation of a radioactive corrosion product in the nuclear reactor by the feed water which returns to the nuclear reactor, metal impurities are removed from the feed water by an ion exchange resin filtering device, such as a desalinization device provided in a water feeding pipe. The feed water is heated to about 200° C. by a feed water heater provided in the water feeding pipe.

A film forming device used in the present embodiment in order to perform the method of suppressing the elution of nickel and cobalt from the structural material will be described with reference to FIG. 1. The film forming device includes a treatment bath 5 into which a structural material for forming a film is inserted, an iron formate tank (iron-ion containing solution tank) 9, a hydrogen peroxide tank (oxidant tank) 11, a hydrazine tank (pH adjuster tank) 13, a decomposition device 8, and an ultrasonic oscillator 18. The ultrasonic oscillator 18 is provided in the treatment bath 5. The two ends of a pipe 17 are connected to an upper end and a lower end of the treatment bath 5, respectively. A circulation pump 20, a valve 21, a heater 7, and valves 23 and 25 are provided in the pipe 17 in this order. The heater 7 may be provided in the treatment bath 5. The two ends of a pipe 33 for bypassing a valve 21 are connected to the pipe 17. A filter 15 and a valve 22 are provided in the pipe 33. A cooler 16 and a valve 24 are provided in a pipe 34, both ends of which are connected to the pipe 17. The pipe 34 is a bypass pipe of the heater 7 and the valve 23. The decomposition device 8 and the valve 26 are provided in a pipe 35 of which the both ends are connected to the pipe 17. The pipe 35 bypasses the valve 25. The iron formate tank 9 is connected to the pipe 17 by a pipe 37. A pump 10 and a valve 27 are provided in the pipe 37. The hydrogen peroxide tank 11 is connected to the pipe 17 by a pipe 38. A pump 12 and a valve 28 are provided in the pipe 38. The hydrazine tank 13 is connected to the pipe 17 by a pipe 39. A pump 14 and a valve 29 are provided in the pipe 39. A pipe 36 having a valve 30 connects the pipe 35 and the pipe 38.

A method of manufacturing a nuclear reactor configuration material, for example, a fuel spacer, will be described with reference to FIG. 2. The fuel spacer is used in a fuel assembly and maintains an interval among a plurality of fuel rods configuring the fuel assembly. The fuel spacer has a spacer grid made of zircaloy and a spacer spring made of inconel. A magnetite film is formed on only the surface of the spacer spring. The spacer spring having a predetermined shape is molded (step 41). Thereafter, preprocesses such as degreasing and cleaning are performed prior to forming the magnetite film (step 42). The degreasing of the spacer spring is performed using acetone, and the surface of the spacer spring is cleaned by purified water. After the step 42, the magnetite film is formed on the surface of the spacer spring (step 43). The process of the step 43 will be described in detail later. Next, the fuel spacer is assembled (step 44). The spacer spring having the magnetite film formed on the surface thereof is attached to the spacer grid manufactured separately. Thus, the fuel spacer is completed.

The method of suppressing the elution of nickel and cobalt from the structural material using the film forming device, that is, a method of forming the magnetite film by the step 43, will be described in detail. First, a predetermined amount of purified water is filled in the treatment bath 5, and a nuclear reactor structural material (for example, a basket 31 in which the spacer spring 32 is placed) is immersed in the purified water in the treatment bath 5. The spacer spring 32 is also immersed in the purified water. The valves 21, 23 and 25 are opened and the valves 22, 24 and 26 to 30 are closed. The purified water in the treatment bath 5 circulates through the pipe 17 by driving the circulation pump 20. The circulating purified water is heated to 90° C. by the heater 7. When the temperature of the purified water reaches 90° C., the valve 27 is opened and the pump 10 is driven. Iron formate (a solution containing iron (II) ions) in the iron formate tank 9 is injected into the pipe 17 to be guided into the treatment bath 5. The injection of iron formate is performed until the concentration of iron (II) ions in the purified water in the treatment bath 5 reaches a setting concentration of 200 ppm or more. The purified water mixed with iron formate is called treatment liquid.

The valve 28 is opened and the pump 12 is driven when the iron formate is uniformly mixed. Hydrogen peroxide in the hydrogen peroxide tank 11 is fed into the pipe 17. Hydrogen peroxide is injected until some of the iron (II) ions (Fe²⁺) contained in the treatment liquid become iron (III) ions (Fe³⁺) in the treatment bath 5. Since the ratio of divalent ions to trivalent ions of the magnetite is 1:2, hydrogen peroxide should not be injected to exceed ⅔ of an equivalent amount of iron (II) ions.

When the concentration of hydrogen peroxide contained in the treatment liquid becomes uniform, the valve 29 is opened and the pump 14 is driven. The hydrazine in the hydrazine tank 13 is injected into the pipe 17 to circulate in the pipe 17 and the treatment bath 5. The pH of the treatment liquid is shifted to an alkali side by the injection of hydrazine. The injection of hydrazine is performed such that the pH of the treatment liquid reaches a setting value. Preferably, the pH of the treatment liquid is adjusted within a range of from 5.5 to 9.0.

Although the heating temperature of the treatment liquid is 90° C., the heating temperature is preferably 100° C. or less. Since the treatment liquid is not boiled by setting the heating temperature to 100° C. or less, the treatment liquid does not need to be pressurized. Accordingly, the film forming device become compact because a pressurizing device is not required.

If the heating temperature is about 25° C. or more, the magnetite film is formed. However, the growth rate of the magnetite film is very low in a region in which the heating temperature is low, even at 25° C. or more. Accordingly, the heating temperature of the treatment liquid is most preferably 60° C. or more such that the magnetite film can be formed at an adequate rate which presents no difficulty in manufacturing the fuel spacer. It was confirmed through an experiment that the magnetite film is formed at the appropriate rate by setting the heating temperature to 60° C. or more. Therefore, the heating temperature of the treatment liquid is preferably in a range of from 25° C. to 100° C. and most preferably in a range of from 60° C. to 100° C.

When the pH of the treatment liquid reaches the setting value by feeding iron formate, hydrogen peroxide and hydrazine into the treatment bath 5, a magnetite production reaction occurs. The magnetite film is formed on the surface of the spacer spring 32 which is immersed in the treatment liquid in the treatment bath 5. At this time, it is preferable that the basket 31 oscillates (shakes) to move the spacer spring 32 in the basket 31 such that the magnetite film is formed on the entire surface of the spacer spring 32. A first magnetite film is formed on the surface of the spacer spring 32 and a second magnetite film is formed on the first magnetite film. When a first predetermined time period elapses after the injection of hydrazine starts, the ultrasonic oscillator 18 is driven to oscillate ultrasonic waves in the treatment liquid in the treatment bath 5. The ultrasonic waves are applied to the spacer spring 32 having the first and second magnetite films formed thereon. Since the spacer spring 32 in the basket 31 oscillates by the ultrasonic waves, the second magnetite film having a weak bonding force is stripped and the second magnetite film is removed from the surface of the spacer spring 32. When a second predetermined time period elapses after the ultrasonic oscillator 18 is driven, the film forming process is finished by pulling up the basket 31 from the treatment bath 5. The spacer spring 32 pulled up from the treatment bath 5 has only the fine first magnetite film as the magnetite film.

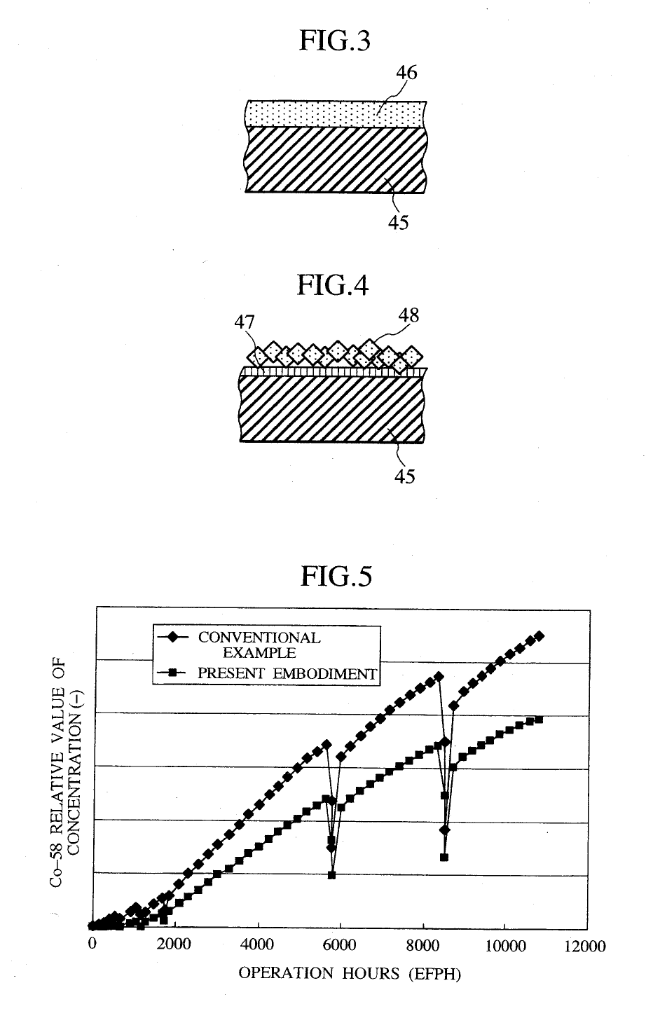

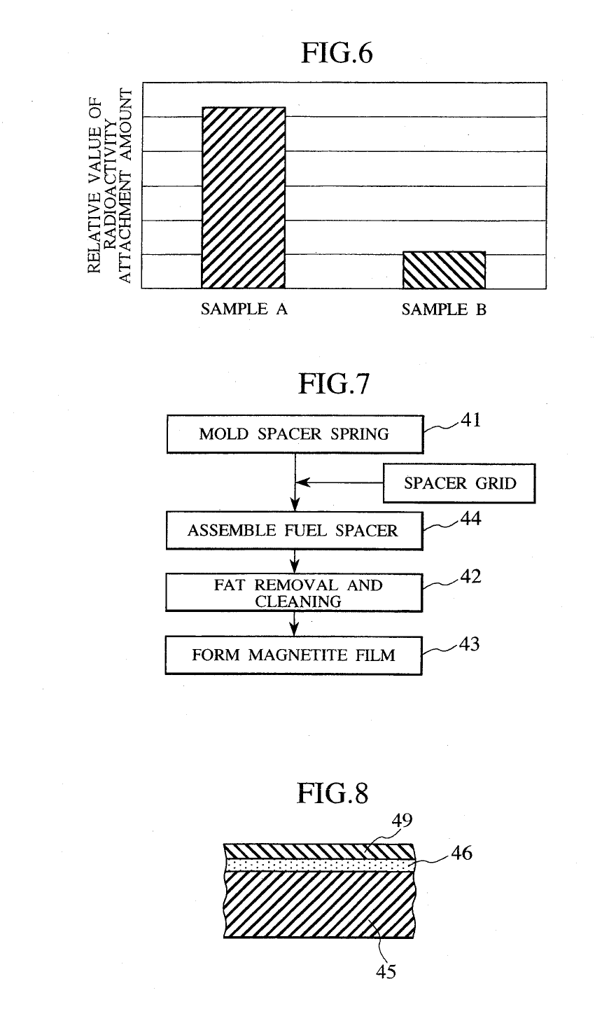

By the process of the step 43, the first magnetite film 46 is formed on the surface of a base metal 45 made of nickel-based alloy (for example, inconel in the spacer spring), as shown in FIG. 3. Since the ultrasonic waves oscillate from the ultrasonic oscillator 18 in the present embodiment, the second magnetite film is not formed on the base metal 45. Accordingly, a fine oxide film containing only iron and oxygen, that is, a fine magnetite (Fe₃O₄) film (first magnetite film 46), is formed on the surface of a nickel-based alloy material (nuclear reactor structural material) which contacts primary cooling water (reactor water). The elution of nickel, which is a main element of the base metal 45, and cobalt, contained as impurities, into the reactor water is reduced by forming the first magnetite film 46. That is, in the temperature of the reactor water while the nuclear reactor is operated, a diffusion rate of metal ions in the first magnetite film 46 is low, and thus the elution of nickel and cobalt into the reactor water is remarkably suppressed.

A thin film 47 mainly containing chrome may be formed on the surface of the structural material which contacts the reactor water as shown in FIG. 4, that is, the base metal (in which the first magnetite film 46 is not formed) 45 made of the nickel-based alloy (for example, inconel in the spacer spring), and a magnetite layer 48 having crystallized magnetite particles laminated thereon is formed on the film 47. Since the reactor water can pass among the magnetite particles in the magnetite layer 48, the diffusion rate of oxygen and metal ions increases. The magnetite layer 48 formed in the present embodiment is different from the first magnetite film 46 in the composition and structure such that the elution of nickel and cobalt from the base metal 45 cannot be suppressed.

After the formation of the first magnetite film using the film forming device is finished, the treatment liquid used in the film forming device may be consigned to a person who treats waste liquid. In the present embodiment, the treatment liquid used in the film forming device (hereinafter, referred to as waste liquid) is converted to the form which is likely to be removed. The treatment of the waste liquid will be described. After the formation of the magnetite film is finished, the valves 21, 25, 27 and 29 are closed. Meanwhile, the valves 22 and 26 are opened. The waste liquid in the treatment bath 5 returns to the treatment bath 5 through the filter 15 and the decomposition device 8 by the rotation of the circulation pump 20. Formic acid contained in the waste liquid and hydrogen peroxide necessary for decomposing hydrazine are fed into the waste liquid received in the pipe 17 by driving the pump 12. Hydrogen peroxide is fed by the amount of 1.2 times the equivalent amount corresponding to the concentration of formic acid and the concentration of hydrazine. By injection of hydrogen peroxide, a Fenton reaction occurs to decompose formic acid and hydrazine, and residual iron (II) ions are changed to iron (III) ions along with the occurrence of the reaction. Since the iron (III) ions have low solubility, oxidized iron is precipitated from the waste liquid. The precipitated oxidized iron is removed from the waste liquid by the filter 15. Formic acid, hydrazine and hydrogen peroxide which are not decomposed and left in the waste liquid flow into the decomposition device 8 to be decomposed to water, carbon dioxide, and nitrogen by the promotion of the decomposition. The second magnetite film removed from the structural material is changed to particles by applying the ultrasonic waves and the second magnetite particles are removed by the filter 15. Accordingly, only the filter 15 remains as the substantial waste.

After the decomposition of formic acid, hydrazine and hydrogen peroxide is finished, the valves 24 and 25 are opened and the valves 23 and 26 are closed. The waste liquid is cooled by the cooler 16. When the temperature of the waste liquid is reduced to, for example, 20° C., the cover of the treatment bath 5 is opened and the basket 31 received therein is extracted from the treatment bath 5. The spacer spring 32 having the first magnetite film formed thereon is extracted from the treatment bath 5.

Although iron formate is used as an agent for feeding the iron (II) ions in the present embodiment, iron chloride (II) or iron nitrate (II), for example, may be used. However, the residual of chloride ions or nitrate ions in the structural material having the first magnetite film formed thereon is not allowed in the structural material used in the nuclear power plant. Accordingly, it is not preferable that the iron chloride (II) or iron nitrate (II) is used in the structural material used in the nuclear power plant. The iron chloride (II) or the iron nitrate (II) is not decomposed and thus increases secondary waste.

As the oxidant, sodium nitrite and ozone water may be used instead of hydrogen peroxide. However, hydrogen peroxide is preferably used in view of the increase of the secondary waste.

As the pH adjuster, any one of sodium hydroxide, potassium hydroxide and ammonia may be used. However, hydrazine is preferable in view of the increase of the secondary waste and the facilitation of decomposition.

The fuel spacer including the spacer spring having the first magnetite film 46 formed thereon is used in a fuel assembly for a boiling water reactor. This fuel assembly has an elution rate of nickel and cobalt smaller than that of a conventional fuel assembly having a conventional spacer spring by about one digit in the atmosphere. The spacer spring 32 manufactured using the method of suppressing the elution of nickel and cobalt from the structural material can remarkably suppress the elution of nickel and cobalt, which are parent nuclides and are contained in the base metal 45 made of inconel, and the elution of cobalt 58 and cobalt 60, which are radioactive nuclides and are contained in the base metal 45. According to the analysis of the model of estimating the radioactivity concentration of the reactor water, the concentration of cobalt 58 in the reactor water in a case of the spacer spring having the first magnetite film formed in the present embodiment is reduced by about 20% compared with a case of using the conventional spacer spring having an auxiliary oxide film, as shown in FIG. 5. Since the concentration of radioactive cobalt in the reactor water is significantly reduced, it is possible to remarkably suppress the radioactive nuclides from being deposited on the structural material. In particular, in the BWR plant having a recirculation pipe, it is possible to suppress the radioactive nuclides from being deposited on the inside of the recirculation pipe. As a result, it is possible to remarkably suppress the dose equivalent received by the worker at the time of the periodic inspection.

Since the ultrasonic waves oscillate from the ultrasonic oscillator when forming the magnetite film in the present embodiment, the coarse second magnetite film having a weak bonding force is removed from the spacer spring 32. Accordingly, the first magnetite film, which has a lower diffusion degree of nickel ions and cobalt ions than that of the second magnetite film, and which is unlikely to be stripped, may be left on the surface of the base metal 45 of the spacer spring. Thus, the fuel assembly including the spacer spring 32 having the first magnetite film 46 formed in the present embodiment can further reduce the elution of the radioactive nuclides and the parent nuclides of the radioactive nuclides, compared with the fuel assembly having the spacer spring including the magnetite film formed in JP-A-2006-38483. The magnetite film formed in JP-A-2006-38483 includes the second magnetite film as well as the first magnetite film. In the structural material according to the present embodiment, since nickel and cobalt are not eluted from the second magnetite film while driving the nuclear reactor like JP-A-2006-38483, it is possible to further reduce the elution of the parent nuclides of the radioactive nuclides.

Instead of the oscillation of the spacer spring 32 by the oscillation of the ultrasonic wave, it is possible to remove the second magnetite film by rubbing the magnetite film with a brush. However, in the case of applying the ultrasonic waves to the spacer spring 32, it is possible to efficiently remove the second magnetite film in a short time, compared with the case of rubbing the magnetite film with the brush. Since a plurality of fuel assemblies are loaded in the core, the number of spacer springs 32 used increases. In order to remove the second magnetite film from the spacer spring 32, the application of the ultrasonic waves is very efficient.

In the method disclosed in JP-A-63-15990 in which the magnetite film is formed on the surface of the stainless substrate to form the magnetic recording medium, a solution containing chlorine and acid, such as a ferrous chloride solution and ferrous sulfate solution, is used as a solution containing the iron (II) ions. This method cannot be used to form the magnetite film for the configuration member in view of ensuring the healthiness of the configuration member of the nuclear power plant.

### Second Embodiment

A method of suppressing the elution of nickel and cobalt from a structural material according to a second embodiment of the present invention will be described. In the first embodiment, the first magnetite film is formed on only the spacer spring of the fuel spacer. In the second embodiment, when the spacer grid and the spacer spring are made of inconel, the first magnetite film is formed on the surfaces of the spacer spring and the spacer grid, that is, the fuel spacer.

A method of manufacturing the fuel spacer according to the present embodiment will be described with reference to FIG. 7. Similarly to the first embodiment, a spacer spring having a predetermined shape is molded (step 41). The spacer spring is assembled in a spacer grid formed separately, thereby assembling the fuel spacer (step 44). Thereafter, similarly to the first embodiment, degreasing and cleaning are performed (step 42) to form a magnetite film (step 43).

The formation of the magnetite film is realized by forming a first magnetite film on the surface of the fuel spacer using the film forming device. That is, instead of the spacer spring of the first embodiment, the fuel spacer is in the basket 31 and immersed in the treatment liquid in the treatment bath 5.

In the present embodiment, the first magnetite film is formed on the surface of the fuel spacer by the same process as the first embodiment using iron formate, hydrogen peroxide, and hydrazine. After the first and second magnetite films are formed, ultrasonic waves oscillate from the ultrasonic oscillator 18 and the second magnetite film is removed from the fuel spacer.

When the fuel assembly having the fuel spacer manufactured in the present embodiment is loaded in a core, the first magnetite film is coated on the entire surface of the fuel spacer, and thus inconel, which is the base metal of the fuel spacer, can be prevented from directly contacting the reactor water. It is possible to remarkably suppress the elution of the parent nuclides of the radioactive nuclides, such as nickel and cobalt, contained in the base metal of the fuel spacer and cobalt 58 generated in the base metal upon driving the nuclear reactor into the reactor water of the radioactive nuclides, due to the existence of the first magnetite film.

It is possible to reduce the thickness of the spacer grid by changing the material of the spacer grid from zircaloy to inconel. The fuel assembly including the spacer grid having a small thickness can reduce pressure loss. Accordingly, in the BWR plant in which the fuel assembly is loaded in the core, the capacity of a mounted internal pump (or a recirculation pump) can be reduced. When the capacity of the internal pump (or the recirculation pump) is not reduced, the flow rate of the core can increase and thus the increased output of the nuclear reactor can be achieved. In the present embodiment, in the nuclear power plant, in particular, the increased output of the nuclear reactor can be obtained and the elution of the parent nuclides (nickel and cobalt) of the radioactive nuclides and the radioactive nuclides (cobalt 58 and 60) can be suppressed by forming the first magnetite film according to the present embodiment on the surface of the fuel spacer.

The effect of the first embodiment can be obtained even in the present embodiment. In the present embodiment, since the ultrasonic waves oscillate from the ultrasonic oscillator 18, the magnetite film formed on the fuel spacer does not contain the second magnetite film. Accordingly, it is possible to further suppress the elution of the parent nuclides and the radioactive nuclides.

### Third Embodiment

A method of suppressing the elution of nickel and cobalt from a structural material according to a third embodiment of the present invention will be described. Although the fine strong magnetite film (first magnetite film) is formed on the surface of the structural material in the first and second embodiments, a hematite film may be formed on the surface of the structural material, instead of the magnetite film. The solubility of the hematite contained in reactor water is lower than that of the magnetite. The diffusion factor of metal ions in the hematite is smaller than that in the magnetite. Accordingly, the hematite film is formed on the surface of the structural material which contacts the primary cooling water, such that the elution of the parent nuclides (nickel and cobalt) of the radioactive nuclides and the radioactive nuclides (cobalt 58 and 60) from the structural material into the primary cooling water is further suppressed compared with the case of forming the first magnetite film. In the present embodiment, the hematite film is formed on the surface of the structural material.

In the present embodiment, for example, the formation of the hematite film on the surface of a pin and a roller provided in a control rod will be described. The present embodiment is applicable to the formation of the hematite film on the surface of the spacer spring of the first embodiment and the formation of the hematite film on the surface of the fuel spacer of the second embodiment. The pin and the roller are made of a nickel-based alloy, for example, inconel.

The control rod is inserted among a plurality of fuel assemblies loaded in the core and has a function for controlling the output of the nuclear reactor. In order to smoothly move the control rod among the fuel assembly at the time of operating the control rod, an insertion end and an extraction end of the control rod are respectively provided in the pin and the roller. The control rod of the BWR plant has a cross-shaped section and includes four blades which extend from the center of an axis in four directions. Each blade has a plurality of neutron absorption rods for filling a neutron absorption material provided therein. In each blade, through-holes are formed in the insertion end located higher than the upper end of the neutron absorption rod and the extraction end located lower than the lower end of the neutron absorption rod. The pin and roller, which are configuration members of the nuclear reactor, are positioned in the through-holes. The pin is attached to the blade and the roller is rotatably provided on the pin. The pin passes through the through-hole provided in the roller. Accordingly, the roller can rotate around the pin.

It is difficult to form the fine hematite film on the configuration member of the nuclear reactor. However, it is possible to form the hematite film on the surface of the configuration member of the nuclear member by forming the first magnetite film described in the first embodiment and changing the first magnetite film to the hematite film. In order to change the first magnetite film to the hematite film, an aqueous solution of an oxidant such as oxygenated water and ozone water is used.

The method of suppressing the elution of nickel and cobalt from the structural material according to the present embodiment will be described. The first magnetite film is formed on the surface of the pin and the roller using the film forming device. The formation of the first magnetite film is performed by immersing the pin and the roller received in the basket 31 into the treatment liquid in the treatment bath 5, similarly to the first embodiment. Since the ultrasonic waves oscillate from the ultrasonic oscillator 18, the second magnetite film formed on the pin and the roller is removed. The first magnetite film is also formed on the inner surface of the through-holes of the roller. The pin and the roller having the first magnetite film formed on the surfaces thereof are extracted from the treatment bath 5.

The pin and the roller having the first magnetite film formed on the surfaces thereof are immersed in oxygenated water filled in a vessel. By this process, the first magnetite of the first magnetite film is changed to the hematite (Fe₂O₃) from the surface thereof. When a portion of the first magnetite film is changed to the hematite film having a predetermined thickness from the surface, the pin and the roller are extracted from the oxygenated water. By this method, the first magnetite film can be entirely changed to the hematite film, but a very long time is required until the change thereof is finished. Thus, when the entire surface of the first magnetite film is changed to the hematite and the thickness of the hematite film reaches the predetermined thickness, the process of changing the first magnetite to the hematite is stopped. That is, the pin and the roller are extracted from the oxygenated water. Instead of oxygenated water, ozone water may be used.

By the above-described process, the first magnetite film 46 and the hematite film 49 are formed on the surfaces of the pin and the roller, as shown in FIG. 8. That is, the first magnetite film 46 is formed on the surface of an inconel material which is the base metal 45 of the pin and the roller, and the hematite film is formed on the surface of the magnetite film 46. When the control rod having the pin and the roller having the films formed thereon is positioned in the core, the reactor water directly contacts the hematite film formed on the pin and the roller.

In the present embodiment in which the hematite film is formed, it is possible to further suppress the elution of the parent nuclides (for example, nickel and cobalt) of the radioactive nuclides and the reactive nuclides (for example, cobalt 58 and cobalt 60) from the base metal 45 into the reactor water, compared with the first and second embodiments in which the first magnetite film is formed and the first magnetite film contacts the reactor water. In the present embodiment, since ultrasonic waves oscillate in the treatment liquid from the ultrasonic oscillator 18 at the time of forming the magnetite film similar to the first embodiment, the coarse second magnetite film having a weak bonding force is prevented from being formed on the surfaces of the pin and the roller. Accordingly, although the process of changing the magnetite to the hematite is performed, the hematite changed from the second magnetite film is not formed on the surfaces of the pin and roller. If the second magnetite film is present and the second magnetite film is changed to the hematite, the hematite is likely to be stripped from the pin and the roller due to the weak bonding force. The hematite having the weak bonding force and including nickel and cobalt, which are the parent nuclides of radioactive cobalt, is stripped from the pin and roller and becomes a transition medium of radioactive cobalt. In the present embodiment, it is possible to remarkably suppress the occurrence of the transition medium of radioactive cobalt. In the present embodiment, the same effect as the first embodiment can be obtained.

Similarly to the first embodiment, the first magnetite film may be formed and remain on the surfaces of the pin and the roller.

Although the hematite film is formed using the aqueous solution of an oxidant in the present embodiment, the hematite film may be formed using a heating furnace, as described below. As described above, the pin and the roller having the first magnetite film formed on the surfaces thereof are introduced into the heating furnace provided in the air atmosphere. The air atmosphere is formed even in the heating furnace. The pin and the roller provided in the heating furnace are heated by the heating furnace, for example, at about 300° C. for a predetermined time. The air (heated gas containing oxygen) heated by this heating process contacts the first magnetite film formed on the surfaces of the pin and the roller so that that the first magnetite film is changed to the hematite film. When the heating furnace is used, it is possible to reduce a time necessary for changing the entire surface of the first magnetite film to the hematite film, compared with the above-described case of using mixed water. However, in the former case, the heating furnace is further required, compared with the latter case.

The hematite film can be formed on the surfaces of the spacer spring and the fuel spacer by the formation of the hematite film according to the above-described method.

### Fourth Embodiment

In the above-described embodiments, at least one of the first magnetite film and the hematite film is formed with regard to the nuclear reactor configuration member using a nickel-based alloy (for example, inconel) as a base metal. Even in a structural material using a cobalt-based alloy (for example, stellite) as the base metal, any one of the first magnetite film and the hematite film can be formed on the basis of the methods described in the first to third embodiments. The cobalt-based alloy (for example, stellite) which contacts primary cooling water of the nuclear reactor is a main cause for generating cobalt 59 which is the parent nuclide of cobalt 60. That is, cobalt 59 is likely to be eluted from the stellite which contacts the reactor water into the reactor water. Stellite is used in a weld overlay of a jet pump used in the BWR plant and a weld overlay of a valve seat formed in a valve body of each valve provided in a primary pipe connected to the nuclear pipe.

The jet pump (or the valve body) is immersed in the treatment liquid received in the treatment bath 5 of the film forming device 4 to form the first magnetite film and the second magnetite film on the surface of the jet pump (or the valve body), similarly to the first embodiment. After the formation of the films is finished, the ultrasonic waves from the ultrasonic oscillator 18 are applied to the jet pump (or the valve body). Thus, the second magnetite film is removed from the jet pump (or the valve body). By the above-described process, the first magnetite film is formed on the surface of the weld overlay of the jet pump (or the weld overlay of the valve seat of the valve body). Even in the present embodiment, it is possible to further suppress the elution of the parent nuclides (for example, nickel and cobalt) of the radioactive nuclides and the radioactive nuclides (for example, cobalt 58 and cobalt 60).

The formation of the hematite film on the surface of the jet pump (or the valve body) is performed using a heated gas containing oxygen or an aqueous solution of an oxidant, as described in the third embodiment. By this process, a portion or all of the first magnetite film formed on the surface of the jet pump (or the valve body) is changed to the hematite film. By forming the hematite film, it is possible to suppress the elution of the parent nuclides (for example, nickel and cobalt) of the radioactive nuclides and the radioactive nuclides (for example, cobalt 58 and cobalt 60) from the stellite material of the jet pump (or the valve body).

With respect to the jet pump (or the valve body) which is previously used in the nuclear power plant, any one of the first magnetite film and the hematite film may be formed by mounting the film forming device in a nuclear reactor containment vessel. When any one of the first magnetite film and the hematite film is formed with respect to the jet pump (or the valve body) provided previously, it is preferable that the existing oxide film is removed by performing chemical decontamination of the jet pump (or the valve body) before forming the film.

When any one of the first magnetite film and the hematite film is formed on the inner surface of the existing pipe connected to the nuclear reactor, the film forming device is connected to the pipe. In this regard, it is preferable that the ultrasonic oscillator is directly attached to the pipe instead of providing the ultrasonic oscillator in the treatment bath 5, and the ultrasonic waves are applied to the pipe to oscillate the pipe. Even in this case, an oxide film formed on the inner surface of the pipe needs to be removed by previously flowing chemical decontamination liquid into the pipe.

While the invention has been described in its preferred embodiments, it is to be understood that the words which have been used are words of description rather than limitation, and that changes within the purview of the appended claims may be made without departing from the true scope and spirit of the invention in its broader aspects.

What is claimed is:

1. A method of suppressing elution of nickel and cobalt from a structural material, the method comprising:
forming an iron oxide film on a surface of the structural material used in a nuclear power plant, which is one of a nickel-based alloy and a cobalt-based alloy and contacts a primary coolant of a nuclear reactor; and
applying ultrasonic waves to the structural material having the iron oxide film formed thereon.

2. The method of suppressing elution of nickel and cobalt from a structural material according to claim 1, wherein the iron oxide film includes at least one of a magnetite film and a hematite film.

3. The method of suppressing elution of nickel and cobalt from a structural material according to claim 2, wherein the iron oxide film includes a hematite film formed by oxidizing a magnetite film.

4. The method of suppressing elution of nickel and cobalt from a structural material according to claim 3, wherein the oxidation is performed by bringing one of an aqueous solution of oxidant and heated gas containing oxygen into contact with the magnetite film.

5. The method of suppressing elution of nickel and cobalt from a structural material according to claim 2, wherein the iron oxide film includes a magnetite film formed by immersing the structural material in a treatment liquid containing a first agent containing iron (II) ions, a second agent containing oxidant, and a third agent for adjusting pH.

6. The method of suppressing elution of nickel and cobalt from a structural material according to claim 1, wherein the structural material includes a nickel-based alloy and is one of a spacer spring, a fuel spacer, and a pin and roller attached to a control rod.

7. The method of suppressing elution of nickel and cobalt from a structural material according to claim 1, wherein the structural material includes a cobalt-based alloy and is one of a pin and roller attached to a control rod, a weld overlay of a jet pump, and a valve seat of a valve.

8. The method of suppressing elution of nickel and cobalt from a structural material according to claim 5, wherein the iron oxide film is formed by heating the treatment liquid at a temperature of about 25° C. to 100° C.

9. The method of suppressing elution of nickel and cobalt from a structural material according to claim 5, wherein the pH of the treatment liquid is in a range of from 5.5 to 9.0.

10. A method of treating a structural material to be installed and exposed to radioactive coolant in a nuclear power plant, said structural material including one of a nickel-based alloy and a cobalt-based alloy, the method comprising:
on a surface of the structural material to be installed, forming an iron oxide film that bonds to the structural material; and
removing a portion of the bonded iron oxide film from the structural material to be installed.

11. A method of treating a structural material to be installed and exposed to radioactive coolant in a nuclear power plant, the method comprising:
forming a first iron oxide film on a surface of the structural material, wherein the structural material includes one of a nickel-based alloy and a cobalt-based alloy;
forming a second iron oxide film on a surface of the first iron oxide film, a bonding force of the second iron oxide film to the structural material being weaker than that of the first iron oxide film to the structural material; and
removing the second iron oxide film from the structural material.

12. An apparatus for treating a structural material to be installed and exposed to radioactive coolant in a nuclear power plant, comprising:
a film-forming device arranged to form an iron oxide film on a surface of the structural material, wherein the structural material includes one of a nickel-based alloy and a cobalt-based alloy; and
an ultrasonic oscillator arranged to apply ultrasonic waves to the structural material having the iron oxide film formed thereon.

13. An apparatus for treating a structural material to be installed and exposed to radioactive coolant in a nuclear power plant, comprising:
a film-forming device arranged to form an iron oxide film on a surface of the structural material such that the iron oxide film bonds to the surface of the structural material to be installed, wherein the structural material includes one of a nickel-based alloy and a cobalt-based alloy; and
a removing device arranged to remove a portion of the bonded iron oxide film from the structural material to be installed.

14. An apparatus for treating a structural material to be installed and exposed to radioactive coolant in a nuclear power plant, comprising:
a film-forming device arranged to form a first iron oxide film on a surface of the structural material, wherein the structural material includes one of a nickel-based alloy and a cobalt-based alloy, and a second iron oxide film on a surface of the first iron oxide film, a bonding force of the second iron oxide film to the structural material being weaker than that of the first iron oxide film to the structural material; and
a removing device arranged to remove the second iron oxide film from the structural material.
